(19) United States
(12) Patent Application Publication
(10) Pub. No.: US 2015/0095370 A1
(43) Pub. Date: Apr. 2, 2015

(54) METHODS FOR AND APPARATUS FOR CONTENT OBJECTIVE PROFILING

(71) Applicant: Talent Portfolio Solutions, New York, NY (US)

(72) Inventor: Robert Davidson, New York, NY (US)

(21) Appl. No.: 14/500,742

(22) Filed: Sep. 29, 2014

Related U.S. Application Data
(60) Provisional application No. 61/884,035, filed on Sep. 28, 2013.

(51) Int. Cl. G06F 17/30; H04L 29/08

(52) U.S. Cl. CPC G06F 17/30864; H04L 67/30
USPC 707/769

(57) ABSTRACT

The present disclosure relates to methods and apparatus for creating and presenting content objective data from a content agnostic profiling system. More specifically, the present disclosure includes computerized apparatus logically connected and programmed to catalog skills, knowledge, and experience of individuals in a content agnostic manner. In some aspects, the present disclosure relates to extracting objective qualities from subjective content. The present disclosure describes a method and apparatus for standardizing qualities and inputs over a plurality of sources, including, for example, one or more of companies, departments, and fields.

### CROSS REFERENCE TO RELATED APPLICATION

This application claims priority to the U.S. Provisional Application 61/884,035 filed on Sep. 28, 2013 and entitled METHODS FOR AND APPARATUS FOR CONTENT OBJECTIVE PROFILING. The contents of which are relied upon and incorporated by reference.

### FIELD OF THE DISCLOSURE

The present disclosure relates to methods and apparatus for creating and presenting content objective data from a content agnostic profiling system. More specifically, the present disclosure includes computerized apparatus logically connected and programmed to catalog skills, knowledge, and experience of individuals in a content agnostic manner. In some aspects, the present disclosure relates to extracting objective qualities from subjective content. The present disclosure describes a method and apparatus for standardizing qualities and inputs over a plurality of sources, including, for example, one or more of companies, departments, and fields.

### BACKGROUND OF THE DISCLOSURE

Human resource data has been used to capture and present data relating to personnel and their professional histories in numerous formats. Known human resources type databases track the type of data quantified in a resume or CV. Typically such data includes employers, positions held, salary, and ratings. The database fields are static and only record and reproduce structured data.

Similarly, on a typical online job board, a search for someone with experience leading global teams” may yield inaccurate results with significant candidate omissions and/or overstatement of responsibilities.

### SUMMARY OF THE DISCLOSURE

Accordingly, what is needed is a system that may allow a user to effectively and efficiently search profile data over multiple groups and entities. The present disclosure describes a content agnostic profiling system, wherein profile attributes and profile attribute qualities may be objectively standardizing. The objective standardization may allow a user to compare profiled individuals utilizing an objective, not subjective, scale. The present disclosure further describes a dynamic searching system that may allow a user to optimize project team rosters. The present disclosure is therefore amenable to the assembling of teams of persons based on inter-personal dynamics, cost, and capabilities to provide greater organizational effectiveness.

One general aspect may comprise a content agnostic profiling system including: a communications network access device configured to access a server in logical communication with a digital communications network; and executable software stored on the communications network access device and executable on demand, the software operative with the communications network access device to cause the network access device.

In some embodiments the content agnostic profiling system also may receive a first profile attribute including a first category of content. The content agnostic profiling system also may comprise receive a first profile attribute quality of a first profiled individual, where the first profile attribute quality may comprise a first quality of the first profiled individual for the first profile attribute. The content agnostic profiling system also may comprise access a profile attribute quality database including a plurality of analyzed profile attribute qualities, where each of the plurality of analyzed profile attribute qualities are associated with a standardized objective identifier. The content agnostic profiling system also may comprise compare the first profile attribute quality to the plurality of analyzed profile attribute qualities. The content agnostic profiling system also may comprise associate the first profile attribute quality to a first standardized objective identifier, where the association is based on the comparison between the first profile attribute quality and the plurality of analyzed profile attribute qualities.

Implementations may comprise one or more of the following features. The content agnostic profiling system where the receiving of the first profile attribute quality may further cause the network access device to: receive a document including content at least partially descriptive of the first profiled individual; extract the first profile attribute quality from the content at least partially descriptive of the first profiled individual. The content agnostic profiling system where the plurality of analyzed profile attribute qualities originate from a plurality of entities. The content agnostic profiling system where the network access device may be further caused to: initiate a first profile for the first profiled individual, where the first profile may comprise at least one profile attribute quality descriptive of the first profiled individual; and assign the first profile attribute quality to the first profile.

In some aspects, the network access device may be further caused to access a profile database including a plurality of profiles, where each of the plurality of profiles may comprise at least one profile attribute quality; and store the first profile in the profile database. The network access device may be further caused to: receive a second profile attribute including a second category of content; receive a second profile attribute quality of the first profiled individual, where the second profile attribute quality may comprise a second quality of the first profiled individual for the second profile attribute; access the profile attribute quality database; compare the second profile attribute quality to the plurality of analyzed profile attribute qualities; associate the second profile attribute quality to a second standardized objective identifier, where the association is based on the comparison between the second profile attribute quality and the plurality of analyzed profile attribute qualities; and assign the second profile attribute quality to the first profile. The content agnostic profiling system where the first profile attribute is received from a first entity and the second profile attribute is received from a second entity.

The network access device may be further caused to: receive a second profile attribute quality of the first profiled individual, where the second profile attribute quality may comprise a second quality of the first profiled individual for the first profile attribute; access the profile attribute quality database; compare the second profile attribute quality to the plurality of analyzed profile attribute qualities; associate the second profile attribute quality to a second standardized objective identifier, where the association is based on the comparison between the second profile attribute quality and the plurality of analyzed profile attribute qualities; and assign the second profile attribute quality to the first profile. The content agnostic profiling system where the first profile attribute is received from a first entity and the second profile attribute is received from a second entity.

The network access device may be further caused to: compare the second profile attribute quality to the first profile attribute quality, where the comparison determines conflicts and similarities between the second profile attribute quality to the first profile attribute quality. The comparison may determine that the first profile attribute quality conflicts with the second profile attribute quality, and where the network access device is further caused to: associate the first profile attribute quality and the second profile attribute quality to an adjusted standardized objective identifier, where the adjusted standardized objective identifier is based on the comparison between the second profile attribute quality and the first profile attribute quality; and replace the first standardized objective identifier and the second standardized objective identifier with the adjusted standardized objective identifier.

The content agnostic profiling system where the plurality of profiles originate from a plurality of entities. The content agnostic profiling system where the network access device is further caused to: prompt input of a first profile attribute including a category of content, where the first profile attribute quality is descriptive of the category of content; and receive the first profile attribute. One general aspect may comprise the content agnostic profiling system where the plurality of profiles originate from a plurality of entities.

One general aspect may comprise a content agnostic profiling system, which may comprise a communications network access device configured to access a server in logical communication with a digital communications network; and executable software stored on the communications network access device and executable on demand, the software operative with the communications network access device to cause the network access device. The content agnostic profiling system also may comprise prompt input of a first profile attribute quality. The content agnostic profiling system also may comprise receive the first profile attribute quality. The content agnostic profiling system also may comprise associate the first profile attribute quality to a first standardized objective identifier. The content agnostic profiling system also may comprise access a profile database including a plurality of profiles, where each of the plurality of profiles may comprise at least one profile attribute quality, where the at least one profile attribute quality is associated with a standardized objective identifier. The content agnostic profiling system also may comprise retrieve a profile search result including any of the plurality of profiles, where at least one profile attribute quality is associated with the first standardized objective identifier. The content agnostic profiling system also may comprise transmit the profile search result.

Implementations may comprise one or more of the following features. The content agnostic profiling system where the plurality of profiles originate from a plurality of entities. The content agnostic profiling system where the network access device is further caused to: prompt input of a first profile attribute including a category of content, where the first profile attribute quality is descriptive of the category of content; and receive the first profile attribute.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1A illustrates an exemplary personal information graphical user interface (GUI) comprising exemplary relevant profile attributes.

FIG. 1B illustrates an exemplary entity information graphical user interface (GUI) comprising exemplary relevant profile attributes.

FIG. 1C illustrates an exemplary professional information graphical user interface (GUI) comprising exemplary relevant profile attributes.

FIG. 2 illustrates a table listing an exemplary assignment of SOI to PAQs from three entities, wherein the profile attribute comprises position title.

FIG. 3 illustrates an exemplary project team builder graphical user interface (GUI) comprising exemplary relevant profile attributes.

FIG. 4 illustrates an exemplary profile information data flow diagram.

FIG. 5 illustrates an exemplary processing and interface system that may be used to implement aspects of the present disclosure.

FIG. 6 illustrates a computing apparatus that may be used to implement aspects of the present disclosure including executable software.

### DETAILED DESCRIPTION

In the following sections, detailed descriptions of examples and methods of the disclosure will be given. The description of both preferred and alternative examples though through are exemplary only, and it is understood that to those skilled in the art that variations, modifications, and alterations may be apparent. It is therefore to be understood that the examples do not limit the broadness of the aspects of the underlying disclosure as defined by the claims.

### GLOSSARY

Content Agnostic Profiling System (CAPS): as used herein refers to an open content profiling system wherein a plurality of profiles may be objectively compared utilizing standardized objective identifiers, wherein profile content may not be limited to predetermined profile attributes or profile attribute qualities.
Entity: as used herein refers to an organization of profiled individuals, such as a company, department, or employer.
Profiled Individual: as used herein refers to an individual whose profile may be generated and included in the CAPS, wherein the generation and/or inclusion may be initiated automatically or manually.
Profile Attribute: as used herein refers to a category of content of a profile.
Profile Attribute Quality (PAQ): as used herein refers to information of a profiled individual for a profile attribute.
Objectively Equivalent: as used herein refers to PAQ that may be associated with the same SOI.
Objectively Similar: as used herein refers to PAQ that be associated with similar SOI, wherein the similarity may be based on a predefined range or a dynamic scale. In some aspects, the similarity may be assessed based on other search criteria, historical search data or trends, or other information that may allow for more relevant similarity.
Standardized Objective Identifier (SOI): as used herein refers to an objective identifier assigned to a PAQ, wherein the object identifier may be standardized within an entity and/or between multiple entities. A SOI may allow for an objective comparison of profiled individuals from a plurality of sources.
User: as used herein refers to any person who may interface with the CAPS.

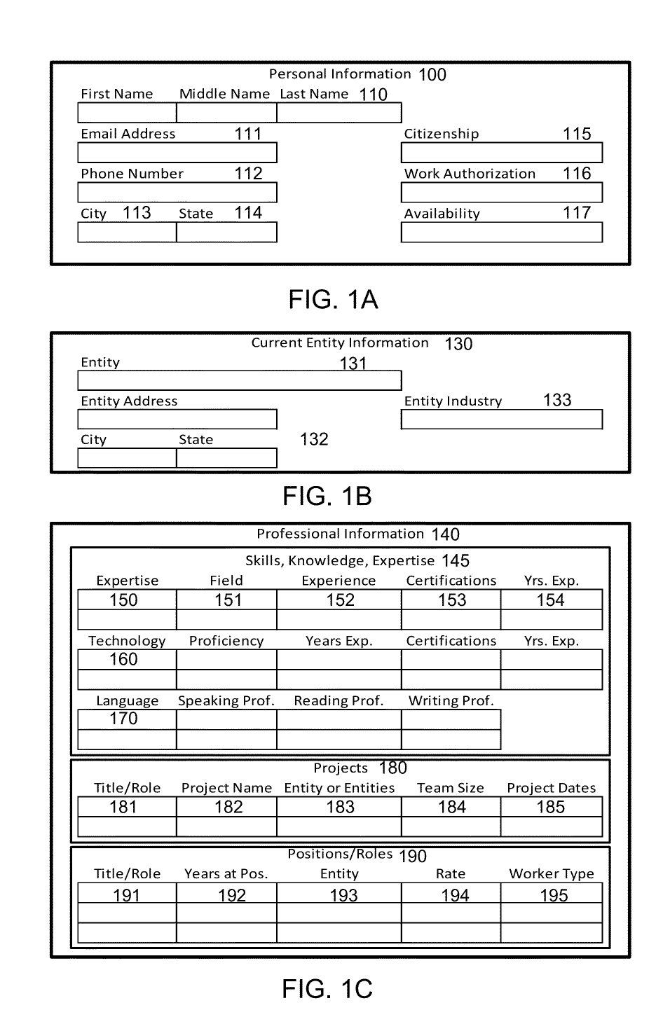

Referring now to FIG. 1A, an exemplary personal information graphical user interface (GUI) 100 comprising exemplary relevant profile attributes is illustrated. In some embodiments, a personal information GUI 100 may provide a snapshot of general personal information of a profiled individual, such as contact information 110-114 and work and travel limitations 115-117.

Basic contact information 110-114 may include geographic location, phone number, email address, time zone, and address. In some embodiments, a profiled individual's email and/or phone number may be hyperlinked for a user's convenience. In some embodiments, there may also be a bar indicating relevance to search criteria. For example, the CAPS may calculate and display a percent relevancy or objective similarity of the profiled individual's data that may appear in search results as compared to the search criteria.

In some embodiments, a user may perform a search with a calendar input. For example, a user may want to search for a profiled individual that may be available during a certain time period. A user may search for availability utilizing a calendar input by choosing a specific day or date range. In some embodiments, a user may narrow a calendar input search by specifying that results show profiles of human resources that may be available 100% or may be partially available.

In some embodiments, a profile may contain links that may allow a user to add a profile to a group and/or save a profile to contacts. In some embodiments, a user may elect to integrate a portable electronic device or cloud storage with functions of adding a profile to a group or to contacts. For example, a user may specify within the program or on a user's portable device or cloud storage to synchronize with a program's saved profile data. In some aspects, a user may access contact data directly from a portable electronic device such as a mobile phone or from cloud storage on any device.

Referring now to FIG. 1B, an exemplary entity information graphical user interface (GUI) 130 comprising exemplary relevant profile attributes is illustrated. In some aspects, an entity information GUI 130 may provide a snapshot of general information regarding an entity that may be relevant to the profiled individual, such as name 131, address 132, and industry 133. For example, relevant entities may comprise a current employer, previous employer, sponsor, or contracting or host company for a project.

Referring now to FIG. 1C, an exemplary professional information graphical user interface (GUI) 140 comprising exemplary relevant profile attributes is illustrated. In some embodiments, the professional information GUI 140 may comprise a skills, knowledge, expertise section 145, projects section 180, and positions/roles section 190. In some aspects, the skills, knowledge, expertise section 145 may provide a snapshot of expertise 150, technology proficiency 160, and language proficiency 170.

In some aspects, the projects section 180 may comprise a list of the projects 182 the profiled individual may have been participated, wherein the listing may further comprise the role 181 of the profiled individual, the entity 183 participants, the team size 184, and the project dates 185. In some implementations, the positions/roles section 190 may provide a historical list of titles/roles 191 of the profiled individual, the years at each position 192, the entity 193 for those positions, the salaries in the rate section 194, and worker type 195 for each role.

In some embodiments, a profile may be completed or partially filled in by extracting objective information from an external document or source, such as, for example, a cover letter, resume, or LinkedIn profile. In some embodiments, an entity or team may determine the visible content of the profiles for their personnel. In some aspects, content of the profiles may be continually or periodically acquired and augmented with input from users and secondary sources, such as emails, resumes, reviews, or project reports.

In some embodiments, a profile may indicate the source or type of source that originated and/or confirmed the PAQ. In some aspects, a profile may be initiated when an individual is hired by or works with an entity that may provide profile data to the CAPS. The initial profile may comprise minimal PAQs, such as personal information. Additional profile attributes may be filled in from a range of sources, including, for example, emails, user input, reports, awards, or other sources with relevant information. Direct user input may comprise apparent subjective PAQs, and a PAQ indicator may alert a user that a PAQ may be unverified.

As more data may be assessed relevant to a profiled individual, the PAQs may be adjusted allowing for a dynamic and current profile. In some embodiments, the CAPS may receive conflicting PAQs for a profiled individual, wherein the SOIs for the PAQs may be compared and reanalyzed. In some aspects, one or both the PAQs may be stored with the profile, and an adjusted SOI may replace the prior SOI.

As an illustrative example, a company in one country may want to hire a profiled individual from another country to work on a project on a team. A company may use an integrated portal to share documents, and CAPS 415 may objectively record and store collaboration activity data between a company and a profiled individual. Collaboration and team data may be integrated automatically or manually into a profile. In some embodiments, entrepreneurial free agents as well independent staffing agencies hiring profiled individuals for companies or other external entities may effectively coordinate and manage human resources in a single program interface, and bid on company projects. In some embodiments, free agents with similar attributes such as a similar level of skill may send each other collaboration proposals, and a recipient of a proposal may accept or reject, ask questions, or may contact a free agent directly via contact information on a profile. In some embodiments, entrepreneurial free agents in the system may assemble teams and collectively bid on company projects.

In some aspects, visibility of and access to profile attributes may be controlled by access level or authorization criteria. For example, a project leader may be granted visibility of profile attributes that may be relevant to the particular project, such as expertise 150, which may pertain to a specific field 151, and any experience 152 (including years of experience 154) and certifications 153 related to that expertise 150. A project leader may be granted visibility of proficiencies and extent of certain technologies proficiencies 160 and languages proficiencies 170, which may be relevant to the project.

In some aspects, a project leader or hiring manager may be granted visibility of prior or current projects section 180 and positions/roles section 190. Where a project leader may be limited to a particular budget, the project leader may be granted limited visibility of cost or income, such as through a pictorial representation. For example, the project leader may not be able to see an annual income or hourly wage in the rate section 194, but the project leader may be able to see a comparative income, such as high/medium/low or one dollar sign to four dollar signs.

In some embodiments, profile attributes may further include honors and awards, publications, patents, or demographic, for example. In some embodiments, a search may be defined by free-form text or a natural language search. In some embodiments, skills, knowledge, or expertise may be listed individually on each profile, and each profile attribute may be hyperlinked. In some aspects, a user may select a profile attribute to read more information about that profile attribute or similar profiles with the same profile attribute. For example, an expertise of C++ may be listed and hyperlinked.

In some embodiments, a user may view data by month, year, week, or day. In some embodiments, a chart or graph may be generated that may show trends and comparisons to other prospective profiled individuals. In some embodiments, a total cost of work for a particular profiled individual for a particular role at a particular rate may be calculated. A user may view this information to calculate budgets for prospective team projects.

In some embodiments, there may be administrative features such as ability to choose a log in alias or identity, taxonomy management, entitlements management, and an ability to manually reconcile duplicate profiles. In some embodiments, a user may utilize system tools where a user may select actions such as feedback or share/email to communicate with other users. In some embodiments, there may be an account management toolbox where a user may manage preferences such as role matching preferences and passwords. In some embodiments, there may be a dashboard that may display quick access to several shortcuts such as a user's favorites, most visited pages, SSO access, and system messages.

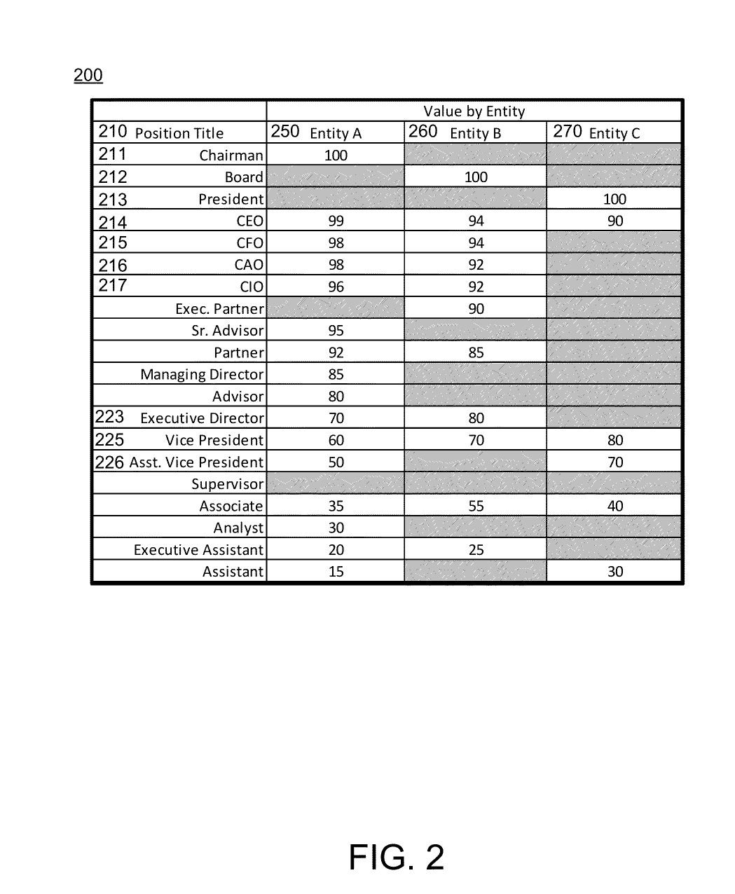

Referring now to FIG. 2, a table 200 listing an exemplary assignment of SOI to PAQs from three entities, wherein the profile attribute comprises position title 210, is illustrated. In some aspects, a CAPS may allow for objective comparison of profiled individuals between multiple entities of varying function, size, infrastructure, and human resource terminology, for example. As a content agnostic system, a user may be able to input and search by a range of profile attributes and PAQs. In some implementations, the CAPS may analyze and compare different profile attribute and PAQ terminology, wherein the CAPS may assign an SOI to each PAQ term and may sort profile attributes.

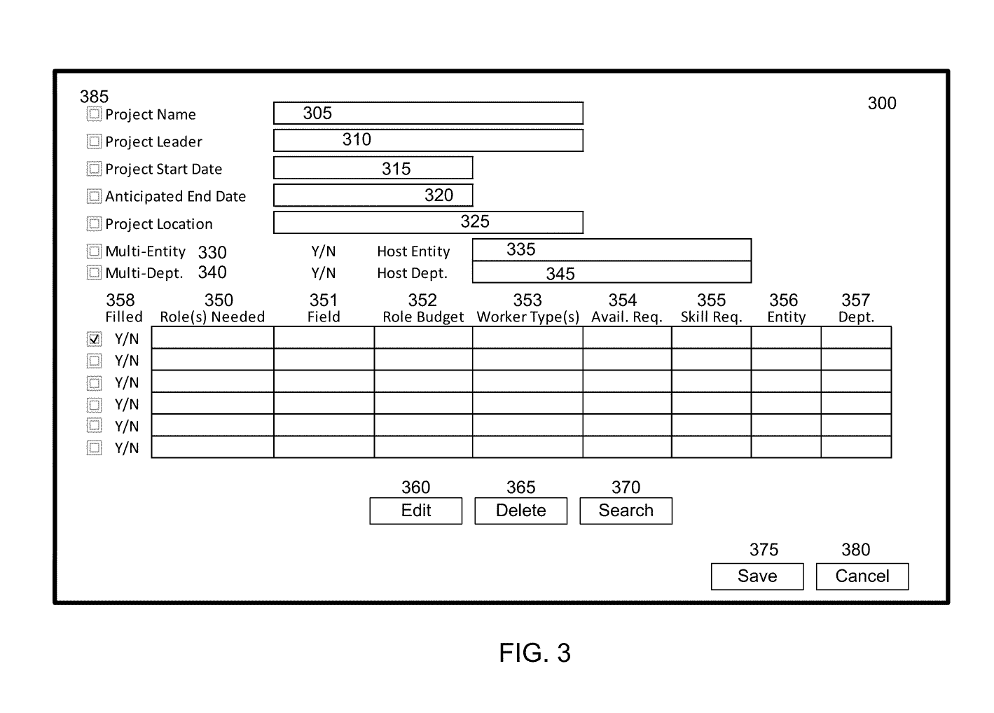

In some embodiments, profiles may be indexed and searchable based on a particular profile attribute or PAQ. A particular PAQ may be desirable for a new hire or a new project, such as illustrated and described in FIG. 3. In some embodiments, a user may input the PAQ according to the terminology utilized within their team, entity, field, or general understanding of the quality. Some PAQ terminology may be objectively similar or objectively equivalent. In some embodiments, PAQ terminology may be associated with an objective identifier, which may allow for broader and more accurate searching of profiles.

As an illustrative example, the table 200 in FIG. 2 shows the assigned SOI for an exemplary range of titles 210 in large entity A 250, medium entity B 260, and small entity C 270. In some aspects, titles may not be the same between different entities, but there may be similar roles, wherein a title in one entity may be essentially the same role as a different title in a second entity. For example, the head of the company may be called chairman 211 in large entity A 250, board 212 in medium entity B 260, and president 213 in small entity C 270. Each title may be objectively equivalent, and each title may be assigned the same SOI, which, as illustrated, is 100 and numeric.

As illustrated, the SOI may be assigned based on relative position, wherein a higher number may signify a higher position. Other SOI structures may be practical and effective. For example, an SOI assigned to a title 210 may be derived from a number of projects, personnel, or resources associated with that position.

In some embodiments, multiple titles 210 across multiple entities may be assigned the same SOI because those titles may comprise lateral positions in an entity. For example, a CFO 215, CAO 216, and CIO 217 may be lateral officers with the same or similar duties, experience, and involvement with a company. As an illustrative example, some entities may be governed by a board with one or more of a CEO 214, a CFO 215, a CAO 216, and a CIO 217, wherein the SOI for each title within an entity may be similar or equivalent and different from other entities. For example, the board in large entity A 250 may comprise SOIs from 96-99; the board in medium entity B 260 may comprise SOIs from 92-94; and the board in small entity C 270 may comprise only a CEO 214 with an SOI of 90.

In some embodiments, the titles and SOIs may become more varied and less standard at non-board levels. For example, the title Vice President 225 may be assigned an SOI of 60 at large entity A 250, 70 at medium entity B 260, and 80 at small entity C 270. The title of Vice President 225 at medium entity B 260 may be objectively equivalent to the Executive Director 223 at large entity A 250 and the Assistant Vice President 226 at small entity C 270.

In some embodiments, a user may limit a search to objectively equivalent or objectively similar profile attributes and PAQs. In some embodiments, objectively similar profile attributes and PAQs may be dynamically defined based on secondary variables, such as, for example, other search parameters and historical search data. In some embodiments, objectively similar PAQs in one search may or may not be objectively PAQs in a second search.

Referring now to FIG. 3, an exemplary project team builder graphical user interface (GUI) 300 comprising exemplary relevant profile attributes is illustrated. In some embodiments, a team leader, human resource person, or any other individual with project team access may have authorization to build a team utilizing a project team builder GUI 300, wherein the authorized individual may develop the roles needed and the PAQs that may be desirable for each role.

In some embodiments, a project team builder GUI 300 may provide a snapshot about the project, wherein at least the general information about the project may be listed, such as, for example, project name 305, project leader 310, a project start date 315, an anticipated end date 320, and project location 325. In some aspects, a project may coordinate personnel from multiple entities and/or departments. The project team builder GUI 300 may identify whether the project team may comprise multiple entities 330 and/or multiple departments 340, and the project team builder GUI 300 may identify the host entity 335 and/or the host department 345. In some embodiments, the host entity 335 and/or the host department 345 may be responsible for funding the projects, hiring the personnel, or managing the team, for example.

In some aspects, the CAPS may allow an authorized user to develop the roles that may be needed for the project, project team builder GUI 300 may provide a snapshot of the team by listing the roles needed 350, the fields 351 for those roles, the role budget 352, the worker types 353, the availability required 354 and the skills required 355 for each role, the actual or intended entity 356, and the actual or intended department 357 for the role. The project team builder GUI 300 may identify whether the role has been filled 358 or assigned.

In some embodiments, the project attribute list may be clickable or there may be a check box column 385, wherein a user may select a specific project attribute or role. In some aspects, the selection may allow a user to edit 360, delete 365, search 370, or other action that may be beneficial for project team development. In some embodiments, a user may edit a role and its requirements and may save 375 or cancel 380 changes from the project team builder GUI 300. In some aspects, a user may search the CAPS directly from the project team builder GUI 300, wherein clicking search 370 may provide a result of profiled individuals who may fit one or more the role requirements listed for the checked role.

In some embodiments, a collection of data on profiled individuals may be presented based on expertise or knowledge, wherein expertise or knowledge may be displayed regardless of status (i.e., employees, consultants, contractors, vendors, students, alumni, student or other candidates). For example, a user may perform a search for “Java Developer,” and CAPS may generate search results for profiled individuals who may have expertise in Java Development.

In some embodiments, the project team builder GUI 300 may comprise color indicators, such as a color band that may indicate worker type 353. In some embodiments, a user may customize color-banding criteria to indicate a specific color for a specific profile attribute, such as worker type 353, field 351, or department 357. In some aspects, a user may assign a particular color to a profile where a profile may have a specified combination of attributes. For example, a user may assign a color band of blue to distinguish profiles that may have a worker type of contractor, role as a computer programmer, and a field of software.

In some embodiments, a user may open a worksheet in a new window to plan for upcoming projects with existing or prospective human resources. In some embodiments, a user may input a budget and may compare the budget to a calculated cost to generate a report or reading of financial surplus or debt. In some embodiments, a user may share a project team cost worksheet with prospective team members or with collaborators. A worksheet may be saved and exported to a user externally or may be sent within a system over a server to synchronize with another user.

In some embodiments, a user may refer to an auto-generated list of parameters under saved people to plan for upcoming projects or to plan for selecting preferred team members. For example, a user may browse through saved people, open each saved person's hyperlink to view a relationship map, and then compare relationship maps of human resources' prior projects. Therefore, a user may determine manually or by automatic suggestion which human resources may have the best compatibility based on previous experience and collaborations for a new team.

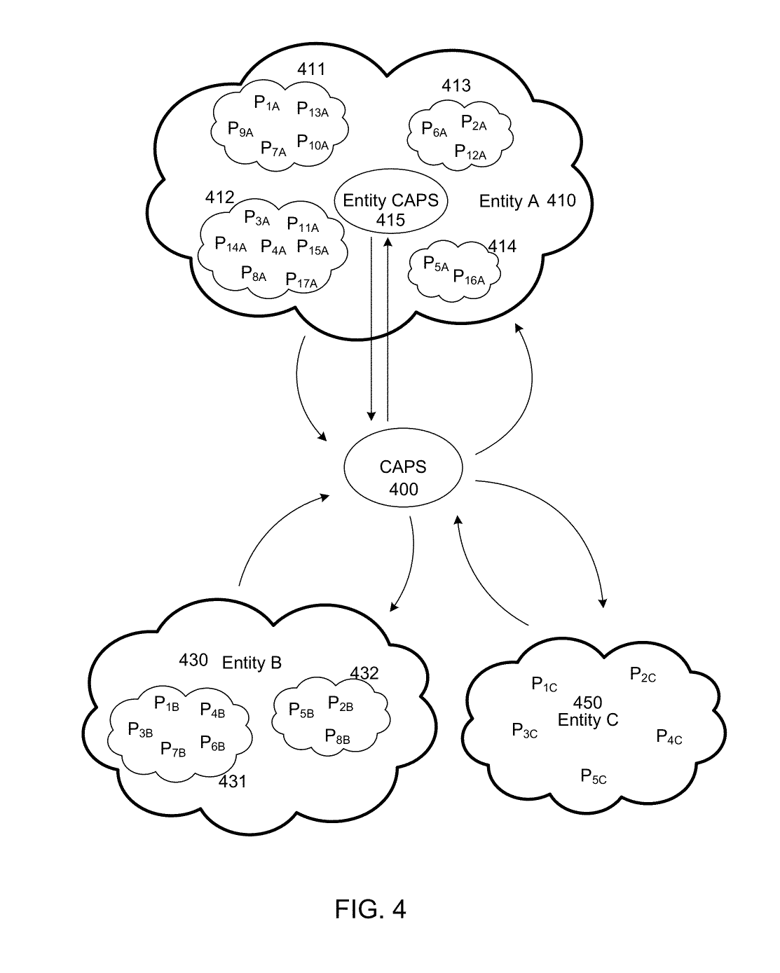

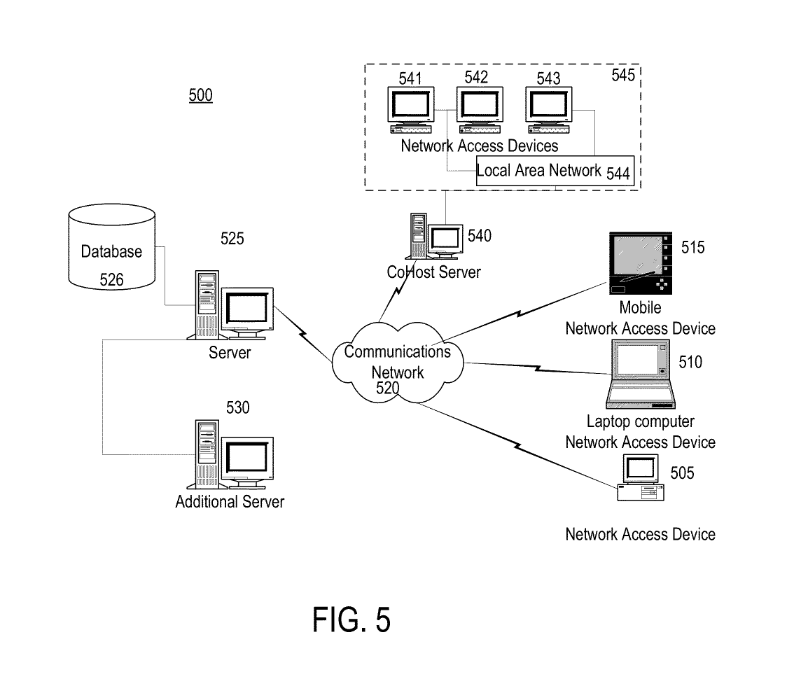

Referring now to FIG. 4, an exemplary profile information data flow diagram is illustrated. In some aspects, a CAPS 400 may comprise a database storing SOIs associated with profile attribute terminology and/or PAQs may be developed. The CAPS 400 may acquire data from multiple entities 410, 430, 450 and sources. In some embodiments, the CAPS 400 may acquire data directly from entity A 410, entity B 430, and entity C 450, such as through a communication network, as illustrated in FIG. 5, for example. In some aspects, some entities may comprise an internal infrastructure, wherein the profile attribute and PAQ terminology may be similar or the same within a group and different between groups. For example, as illustrated, entity A 410 may comprise four groups of entity A personnel 411-414, and entity B 430 may comprise two groups of entity B personnel 431, 432. Some entities may not be organized into groups, such as entity C 450, which may be small enough that profile attribute and PAQ terminology may be relatively homogeneous within entity C 450.

In some aspects, an entity may maintain a separate entity CAPS 415, wherein profile data for entity personnel may be acquired and stored. In some embodiments, the entity CAPS 415 may monitor and/or control the exchange and transfer of data between the entity database and the CAPS 400. In some aspects, the entity CAPS 415 may analyze and assign SOIs to profile attributes and PAQs for profiles of entity A personnel 411-414 within entity A 410.

In some embodiments, one or more of the CAPS 400 database and entity CAPS 415 databases may be developed based on an internal hierarchy of an entity, which may be extracted from human resource data and/or may be developed through objective comparison of multiple profiles. The multiple profiles and the human resource data may be accumulated and compared over multiple teams, entities, fields, or other groups that may comprise similar profile attributes.

Referring now to FIG. 5, an exemplary processing and interface system 500 is illustrated. In some aspects, access devices 515, 510, 505, such as a mobile device 515 or laptop computer 510 may be able to communicate with an external server 525 though a communications network 520. The external server 525 may be in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such as PayPal or a social network, such as Facebook or a dating website.

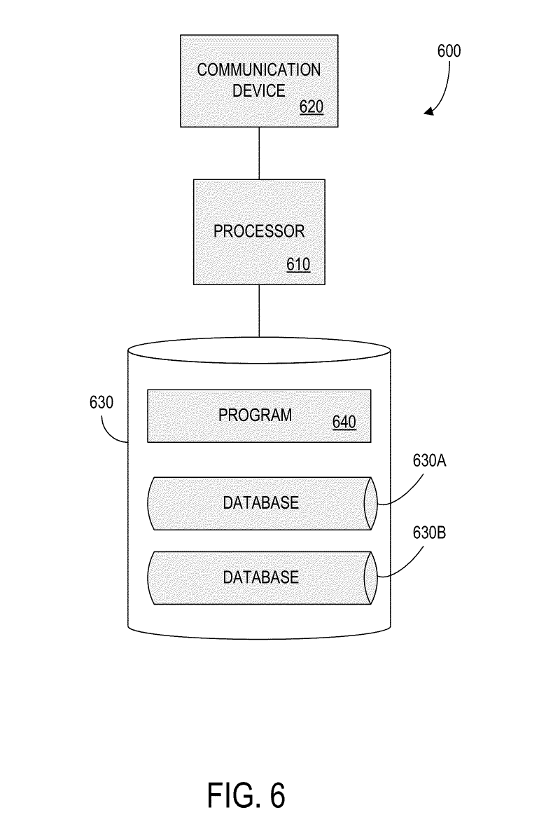

Referring now to FIG. 6, a controller 600 that may be embodied in one or more of the above listed devices and utilized to implement some embodiments of the present disclosure is illustrated. In some embodiments, the controller 600 may comprise a processor 610, such as one or more processors, coupled to a communication device 620 configured to communicate via a communication network (not shown in FIG. 6). In some aspects, the communication device 620 may be used to communicate, for example, with one or more online devices, such as a personal computer, laptop, or a handheld device.

In some aspects, the processor 610 may be in electrical and/or logical communication with a storage device 630. The storage device 630 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

In some embodiments, the storage device 630 may store a program 640 for controlling the processor 610. The processor 610 may perform instructions of the program 640, and thereby may operate in accordance with the present disclosure. In some aspects, the processor 610 may cause the communication device 620 to transmit information, including, for example, control commands to operate apparatus to implement the processes described above. In some implementations, the storage device 630 may additionally store related data in a database 630A and database 630B, as needed.

In some embodiments, a database, either 630A or 630B, may contain user history, cache, and data. In some embodiments, a database, either 630A or 630B, may contain profile data and meta-analysis data. In some embodiments, data from program operation may be mixed throughout multiple databases or may be assigned, organized, or indexed into separate databases. A database may be contained in a subfolder within a storage device 630.

### CONCLUSION

A number of embodiments of the present disclosure have been described. While this specification contains many specific implementation details, they should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A content agnostic profiling system comprising:
a communications network access device configured to access a server in logical communication with a digital communications network; and
executable software stored on the communications network access device and executable on demand, the software operative with the communications network access device to cause the network access device to:
receive a first profile attribute comprising a first category of content;
receive a first profile attribute quality of a first profiled individual, wherein the first profile attribute quality comprises a first quality of the first profiled individual for the first profile attribute;
access a profile attribute quality database comprising a plurality of analyzed profile attribute qualities, wherein each of the plurality of analyzed profile attribute qualities are associated with a standardized objective identifier;
compare the first profile attribute quality to the plurality of analyzed profile attribute qualities; and
associate the first profile attribute quality to a first standardized objective identifier, wherein the association is based on the comparison between the first profile attribute quality and the plurality of analyzed profile attribute qualities.

2. The content agnostic profiling system of claim 1, wherein the receiving of the first profile attribute quality further causes the network access device to:
receive a document comprising content at least partially descriptive of the first profiled individual;
extract the first profile attribute quality from the content at least partially descriptive of the first profiled individual.

3. The content agnostic profiling system of claim 1, wherein the plurality of analyzed profile attribute qualities originate from a plurality of entities.

4. The content agnostic profiling system of claim 1, wherein the network access device is further caused to:
initiate a first profile for the first profiled individual, wherein the first profile comprises at least one profile attribute quality descriptive of the first profiled individual; and
assign the first profile attribute quality to the first profile.

5. The content agnostic profiling system of claim 4, wherein the network access device is further caused to:
access a profile database comprising a plurality of profiles, wherein each of the plurality of profiles comprises at least one profile attribute quality; and
store the first profile in the profile database.

6. The content agnostic profiling system of claim 5, wherein the plurality of profiles originate from a plurality of entities.

7. The content agnostic profiling system of claim 4, wherein the network access device is further caused to:
receive a second profile attribute comprising a second category of content;
receive a second profile attribute quality of the first profiled individual, wherein the second profile attribute quality comprises a second quality of the first profiled individual for the second profile attribute;
access the profile attribute quality database;
compare the second profile attribute quality to the plurality of analyzed profile attribute qualities;
associate the second profile attribute quality to a second standardized objective identifier, wherein the association is based on the comparison between the second profile attribute quality and the plurality of analyzed profile attribute qualities; and
assign the second profile attribute quality to the first profile.

8. The content agnostic profiling system of claim 7, wherein the first profile attribute is received from a first entity and the second profile attribute is received from a second entity.

9. The content agnostic profiling system of claim 4, wherein the network access device is further caused to:
receive a second profile attribute quality of the first profiled individual, wherein the second profile attribute quality comprises a second quality of the first profiled individual for the first profile attribute;
access the profile attribute quality database;
compare the second profile attribute quality to the plurality of analyzed profile attribute qualities;
associate the second profile attribute quality to a second standardized objective identifier, wherein the association is based on the comparison between the second profile attribute quality and the plurality of analyzed profile attribute qualities; and
assign the second profile attribute quality to the first profile.

10. The content agnostic profiling system of claim 9, wherein the first profile attribute is received from a first entity and the second profile attribute is received from a second entity.

11. The content agnostic profiling system of claim 9, wherein the network access device is further caused to:
compare the second profile attribute quality to the first profile attribute quality, wherein the comparison determines conflicts and similarities between the second profile attribute quality to the first profile attribute quality.

12. The content agnostic profiling system of claim 11, wherein the comparison determines that the first profile attribute quality is in conflict with the second profile attribute quality, and wherein the network access device is further caused to:
associate the first profile attribute quality and the second profile attribute quality to an adjusted standardized objective identifier, wherein the adjusted standardized objective identifier is based on the comparison between the second profile attribute quality and the first profile attribute quality; and
replace the first standardized objective identifier and the second standardized objective identifier with the adjusted standardized objective identifier.

13. A content agnostic profiling system comprising:
a communications network access device configured to access a server in logical communication with a digital communications network; and
executable software stored on the communications network access device and executable on demand, the software operative with the communications network access device to cause the network access device to:
prompt input of a first profile attribute quality;
receive the first profile attribute quality;
associate the first profile attribute quality to a first standardized objective identifier
access a profile database comprising a plurality of profiles, wherein each of the plurality of profiles comprises at least one profile attribute quality, wherein the at least one profile attribute quality is associated with a standardized objective identifier;
retrieve a profile search result comprising any of the plurality of profiles, wherein at least one profile attribute quality is associated with the first standardized objective identifier; and
transmit the profile search result.

14. The content agnostic profiling system of claim 13, wherein the plurality of profiles originate from a plurality of entities.

15. The content agnostic profiling system of claim 13, wherein the network access device is further caused to:
prompt input of a first profile attribute comprising a category of content, wherein the first profile attribute quality is descriptive of the category of content; and
receive the first profile attribute.
